(19) United States
(12) Patent Application Publication
(10) Pub. No.: US 2011/0022911 A1
(43) Pub. Date: Jan. 27, 2011

(54) SYSTEM PERFORMANCE TEST METHOD, PROGRAM AND APPARATUS

(76) Inventor: Yasuhiro Ajiro, Tokyo (JP)

Correspondence Address: Mr. Jackson Chen, 6535 N. STATE HWY 161, IRVING, TX, 75039, US

(21) Appl. No.: 12/922,788

(22) PCT Filed: Mar. 26, 2009
(86) PCT No.: PCT/JP2009/056073

§ 371 Date: Sep. 15, 2010

(30) Foreign Application Priority Data
Apr. 21, 2008 (JP) 2008-110326

(51) Int. Cl. G06F 11/263

(52) U.S. Cl. 714/739; 714/E11.177

(57) ABSTRACT

A system performance test method for testing performance of a server system includes: (A) a step of issuing a plurality of types of request sequences with a specified issuance ratio to the server system; and (B) a step of measuring performance of the server system during processing of the plurality of types of request sequences. Each of the plurality of types of request sequences is comprised of a sequence of requests to the server system.

### TECHNICAL FIELD

The present invention relates to a technique for testing performance of a server system. In particular, the present invention relates to a technique that tests performance of a server system by applying practical load.

### BACKGROUND ART

A server system receives a request from a client, processes the request and returns the processing result as a response back to the client. A representative one of such a server system is a Web server system. A user operates a Web browser of a client terminal to execute various actions. The client terminal sends a request depending on the user's action to a Web server specified by a URL. The Web server processes the request and returns the processing result to the client terminal. The client terminal notifies the user of the processing result through the Web browser. The Web server system that processes the request from the client in a short period of time is generally called “transaction system”.

In general, when a performance test of a Web server is performed, a server test apparatus connected to the test-target Web server is used. The server test apparatus transmits virtual requests (test data) to the test-target Web server to apply access load on the Web server. Then, the server test apparatus observes the state of the Web server to evaluate the performance of the Web server. The followings are known as techniques related to such a performance test.

Japanese Patent Publication JP-2002-7232 discloses a performance test method that assumes a case where a large amount of HTTP requests from a large number of user agents (Web browsers) are concurrently transmitted to a Web server. A server test apparatus transmits the large amount of HTTP requests faking the large number of user agents to the test-target Web server concurrently. Then, the server test apparatus recognizes HTTP responses from the test-target server separately, and determines whether or not an object specified by each HTTP request is precisely included in each response. Moreover, the server test apparatus changes a parameter included in the HTTP request and changes an output frequency of the HTTP request. Consequently, it is possible to variably set the test condition.

Japanese Patent Publication JP-2007-264967 discloses a scenario generation program. A scenario defines an order of requesting a page data in a Web server and is given to a plurality of virtual Web clients realized by a server test apparatus. The plurality of virtual Web clients perform transmission of a request message and reception of a response message in accordance with the given scenario. The scenario generation program generates a scenario by which each virtual Web client can properly perform the transmission of the request message and the reception of the response message. For example, the scenario generation program generates a scenario so as to prevent a situation where the Web server makes a time-out decision and the virtual Web client cannot obtain an appropriate response message.

Japanese Patent Publication JP-2003-131907 discloses a method of evaluating performance of a Web system. A plurality of clients connected to the Web system as a target of the performance evaluation are virtually realized. Load is imposed on the Web system, and information on the performance of the Web server including bottleneck is measured. Then, an evaluation result including the information and information on bottleneck avoidance is output.

Japanese Patent Publication JP-2003-173277 discloses a performance measurement apparatus for a server system. The performance measurement apparatus is provided with a condition input screen in which a plurality of different measurement conditions can be concurrently input. Then, the performance measurement apparatus automatically and successively executes performance tests of the server system under the plurality of different measurement conditions.

Japanese Patent Publication JP-2005-332139 discloses a method of supporting generation of a test data for a Web server. A data transmission and reception section transmits a request data to the Web server based on UML received from an input device. Moreover, the data transmission and reception section passes a response data received from the Web server to an HTML registration section. The HTML registration section extracts an HTML data included in the response data and records it in a scenario data. A variable data edit processing section reads the scenario data and has a display device display a screen related to the HTML data and a list associated with a form.

### DISCLOSURE OF INVENTION

The inventor of the present application has recognized the following points. In a performance test of a server system, it is desirable to apply load being as practical as possible on the server system. For example, let us consider a case where a user accesses a shopping site in a Web server system. An action pattern of the user is completely different between a case where the user just browses items and a case where the user selects and purchases a desired item. To take such various action patterns into consideration is considered to be important in order to apply the practical load on the server system in the performance test. However, the various action patterns of the user are not fully taken into consideration in the existing performance test methods.

An object of the present invention is to provide a technique that can perform a performance test of a server system by applying practical load on the server system.

In a first aspect of the present invention, a system performance test method for testing performance of a server system is provided. The system performance test method includes: (A) a step of issuing a plurality of types of request sequences with a specified issuance ratio to the server system; and (B) a step of measuring performance of the server system during processing of the plurality of types of request sequences. Each of the plurality of types of request sequences is comprised of a sequence of requests to the server system.

In a second aspect of the present invention, a system performance test program which causes a computer to execute performance test processing that tests performance of a server system is provided. The performance test processing includes: (A) a step of issuing a plurality of types of request sequences with a specified issuance ratio to the server system; and (B) a step of measuring performance of the server system during processing of the plurality of types of request sequences.

In a third aspect of the present invention, a system performance test apparatus for testing performance of a server system is provided. The system performance test apparatus has: an execution module configured to issue a plurality of types of request sequences with a specified issuance ratio to the server system; and a performance evaluation module configured to measure performance of the server system during processing of the plurality of types of request sequences.

In a fourth aspect of the present invention, a request issuance program is provided. The request issuance program causes a computer to execute: (a) a step of issuing a plurality of types of request sequences with a specified issuance ratio to a server system; and (b) a step of executing the (a) step until a predetermined abort condition is satisfied. Each of the plurality of types of request sequences is comprised of a sequence of requests to the server system.

According to the present invention, it is possible to perform the performance test of the server system by applying practical load on the server system.

### BRIEF DESCRIPTION OF DRAWINGS

The above and other objects, advantages and features of the present invention will be more apparent from the following description of certain exemplary embodiments taken in conjunction with the accompanying drawings.

FIG. 1 is a conceptual diagram for explaining brief overview of the present invention.

FIG. 2 is a conceptual diagram showing an example of a request issuance program according to an exemplary embodiment of the present invention.

FIG. 3A is a conceptual diagram showing another example of a request issuance program according to the exemplary embodiment of the present invention.

FIG. 3B is a conceptual diagram showing another example of a request issuance program according to the exemplary embodiment of the present invention.

FIG. 4 is a block diagram showing a configuration of a system performance test apparatus according to the exemplary embodiment of the present invention.

FIG. 5 is a block diagram showing functions of the system performance test apparatus according to the exemplary embodiment of the present invention.

FIG. 6 is a flow chart showing a system performance test method according to the exemplary embodiment of the present invention.

FIG. 7 is a block diagram showing functions of a request issuance program generation module according to the exemplary embodiment of the present invention.

FIG. 8 is a conceptual diagram showing an example of a performance report data generated in the exemplary embodiment of the present invention.

### DESCRIPTION OF EMBODIMENTS

1. Brief Overview

In a performance test of a server system, it is desirable to apply load being as practical as possible on the server system. To this end, the inventor of the present application has recognized the following points.

The performance of the server system (transaction system) is often expressed by the number of requests that can be processed per a unit time (throughput). It should be noted that the throughput depends also on a type of request. The reason is that system resources and time required for processing of a request greatly differ depending on the type of the request. For example, in a case of a request for browsing an item on a Web page, a Web server merely returns the item data stored in a memory or a disk, and its load is comparatively light. On the other hand, in a case such as a request for adding an item to a cart, the Web server needs to rewrite data on a memory or a disk, and its load is heavier than that in the case of browsing items. In this manner, the performance and load of the server system depends on the type of request. It is therefore important to apply load depending on the type of request when testing the performance of the server system.

Moreover, regarding a Web application in recent years, the server may retain information of a request which has been already issued by a user. For example, the Web server may internally retain information of items which a user has selected in the past in a shopping site. Therefore, in order to apply intended load in the performance test of the Web server, it is also important to issue requests in a fixed order. Such a set of requests that are issued in a fixed order will be hereinafter referred to as a “request sequence”. A single request sequence corresponds to a sequence of actions of a user having a certain purpose and is comprised of a sequence of requests to the server system. It can also be said that the request sequence reflects an action pattern of a user having a certain purpose.

Furthermore, the action pattern of a user accessing the server system is various. For example, let us consider a case where the user accesses a shopping site in a Web server system. The action pattern of the user is completely different between a case where the user just browses items and a case where the user selects and purchases a desired item. To take such various action patterns of the user into consideration is important in order to apply the practical load on the server system in the performance test. Therefore, according to the present invention, a plurality of types of request sequences respectively reflecting the various action patterns arc prepared beforehand. That is, typical user action patterns are classified and provided as the plurality of types of request sequences.

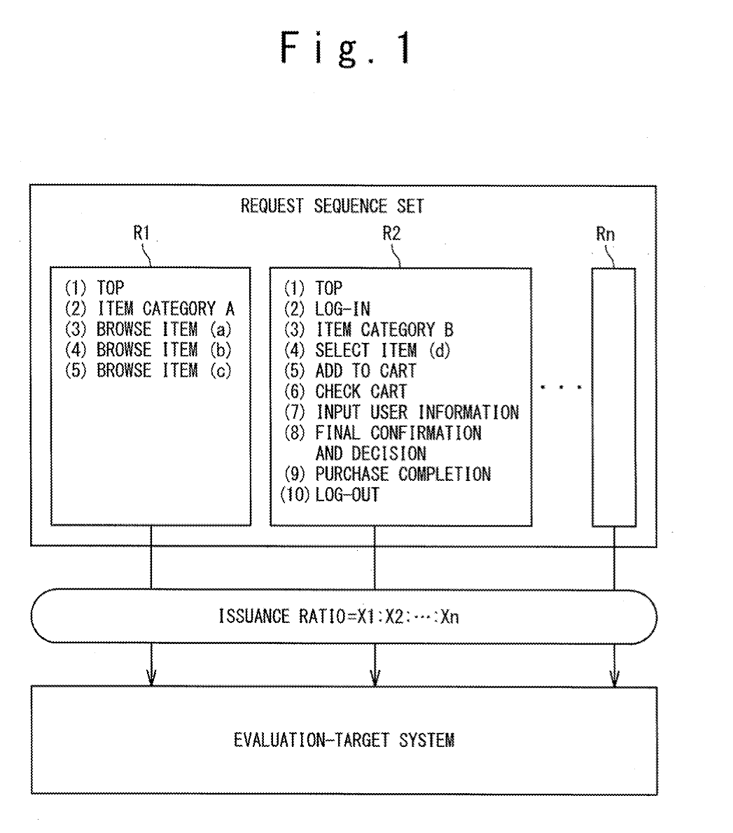

For example, as shown in FIG. 1, a request sequence set including n types of request sequences R1 to Rn is prepared beforehand (n is an integer equal to or larger than 2). Each of the request sequences R1 to Rn is comprised of a sequence of requests to the server system. That is, the n types of request sequences R1 to Rn respectively correspond to n types of action patterns which are different from each other.

For example, the request sequence R1 reflects an action pattern of a user intended to browse items. The user intended to browse items typically moves in the site as follows: “top, select item category [A], browse item [a], browse item [b], browse item [c]”. A sequence of requests issued by a Web browser and the like in response to the movements corresponds to the one request sequence R1.

Also, the request sequence R2 reflects an action pattern of a user intended to purchase a specific item. The user intended to purchase a specific item typically moves in the site as follows: “top, log-in, select item category [B], select item [d], add to cart, check cart, input user information (e.g. address, card number), final confirmation and decision, purchase completion, log-out”. A sequence of requests issued by a Web browser and the like in response to the movements and operations corresponds to the one request sequence R2. The request sequence R2 is different from the above-mentioned request sequence R1.

In this manner, the various action patterns arc classified and thus the plurality of types of request sequences R1 to Rn are generated. Then, as shown in FIG. 1, the plurality of types of request sequences R1 to Rn are issued with respect to the server system as the performance evaluation target (hereinafter referred to as an “evaluation-target system”). Consequently, load in which the various action patterns of the user are considered can be applied to the evaluation-target system. That is, it is possible to apply practical load to the evaluation-target system in the performance test.

It should be noted here that the performance of the server system depends also on the type of request, as mentioned above. Since different request sequences include different requests, the load applied to the server system is naturally different between the different request sequences. Therefore, when the plurality of types of request sequences R1 to Rn are issued to the evaluation-target system, the performance of the evaluation-target system is considered to depend also on an issuance ratio (mixture ratio) of the plurality of types of request sequences R1 to Rn. Let us consider a case where the issuance ratio of the request sequences R1 to Rn is expressed by X1:X2: . . . :Xn (X1 to Xn are integers), as shown in FIG. 1. By variably setting the issuance ratio, it is possible to issue the plurality of types of request sequences R1 to Rn with various ratios with respect to the evaluation-target system. That is, it is possible to test the performance of the evaluation-target system that varies depending on the issuance ratio.

As described above, the present invention is based on a standpoint that the performance of the real server system (transaction system) is determined by the issuance ratio of the plurality of types of request sequences. In the performance test of the evaluation-target system, the plurality of types of request sequences R1 to Rn are issued to the evaluation-target system with the specified issuance ratio X1:X2: . . . :Xn, as shown in FIG. 1. Consequently, it is possible to execute the performance test of the evaluation-target system while applying the practical load to the evaluation-target system. Hereinafter, concrete configuration and method for achieving the processing shown in FIG. 1 will be described.

2. Request Issuance Program

The processing shown in FIG. 1 can be programmed. A computer program which causes a computer to execute the processing shown in FIG. 1 is hereinafter referred to as a “request issuance program PREQ”. The request issuance program PREQ issues the plurality of types of request sequences R1 to Rn to the evaluation-target system with a specified issuance ratio.

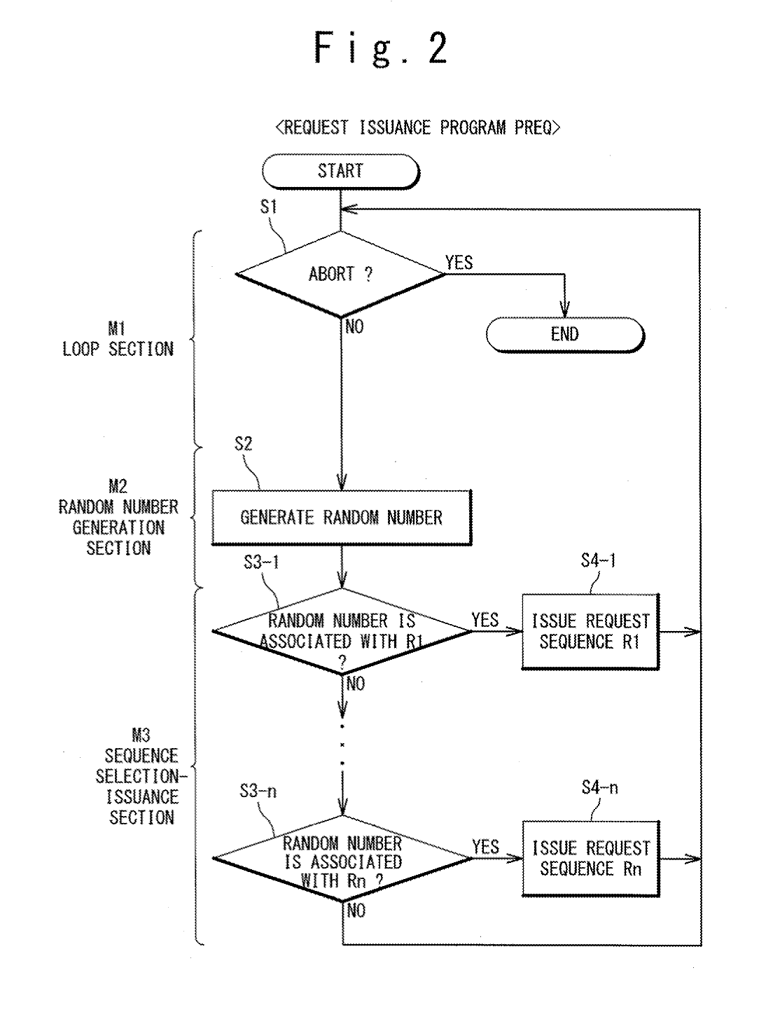

FIG. 2 conceptually shows an example of the request issuance program PREQ according to the present exemplary embodiment. As shown in FIG. 2, the request issuance program PREQ has a loop section M1, a random number generation section M2 and a sequence selection-issuance section M3.

The loop section M1 determines whether or not to stop the processing by the request issuance program PREQ. If a predetermined abort condition is satisfied (Step S1; Yes), the loop section M1 stops the processing. The predetermined abort condition is exemplified by “30 minutes has passed since the start of program execution”, “key input by a user” and the like. If the abort condition is not satisfied (Step S1; No), the subsequent processing is executed.

In the subsequent processing, the plurality of types of request sequences R1 to Rn are issued with the specified issuance ratio. To this end, the following method can be considered. The issuance ratio of the request sequences R1 to Rn is X1:X2: . . . :Xn (X1 to Xn are integers). Here, the i-th request sequence Ri is related to Xi numbers (i=1 to n). As an example, let us consider a case where the issuance ratio of three types of request sequences R1, R2 and R3 is 3:5:2. The request sequence R1 is related to three numbers (figures) 0 to 2, the request sequence R2 is related to five numbers 3 to 7, and the request sequence R3 is related to two numbers 8 to 9. In this case, it is possible to select the three types of request sequences R1, R2 and R3 with the desired ratio 3:5:2 by randomly generating the numbers from 0 to 9.

Therefore, the random number generation section M2 generates random numbers (Step S2). That is, the random number generation section M2 randomly generates a plurality of numbers (figures). The plurality of numbers needs to include at least numbers that are respectively related to the plurality of types of request sequences R1 to Rn. In the case of the above-mentioned example, the random number generation section M2 randomly generates numbers equal to or more than 0 and less than 10. To this end, a function provided by a hardware or a library for programming language processing may be utilized. For example, a built-in function that returns decimal number (floating-point number) type uniform random numbers equal to or more than 0 and less than 1 is publicly known. When the built-in function is expressed by rand( ) the integer type random numbers equal to or more than 0 and less than 10 can be obtained by using an integer part of rand( )×10. What kind of random numbers is to be generated can be determined from the issuance ratio X1:X2: . . . :Xn (or the summation X1+X2+ . . . +Xn).

Next, the sequence selection-issuance section M3 selects and issues one request sequence that is related to the one number (random number) obtained by the random number generation section M2. That is, the sequence selection-issuance section M3 selects a request sequence related to the number from the plurality of types of request sequences R1 to Rn (Step S3) and issues the selected request sequence to the evaluation-target system (Step S4). For example, in a case where the generated number is associated with the request sequence R1 (Step S3-1; Yes), the request sequence Ri is issued (Step S4-1). In a case where the number is not associated with the request sequence R1 (Step S3-1; No), whether or not it is associated with the next request sequence R2 is determined. In the above-mentioned example, the request sequence R1 is selectively issued if the number is any of 0 to 2, the request sequence R2 is selectively issued if the number is any of 3 to 7, and the request sequence R3 is selectively issued if the number is any of 8 to 9.

The processing by the random number generation section M2 and the sequence selection-issuance section M3 is executed repeatedly until the above-described abort condition is satisfied. In each loop, a random number is generated and then a request sequence related to the random number is selectively issued. By repeating this, it is possible to issue the plurality of types of request sequences R1 to Rn with the specified issuance ratio X1:X2: . . . :Xn. It should be noted that the correspondence relation between the number and each request sequence is not limited to the above example.

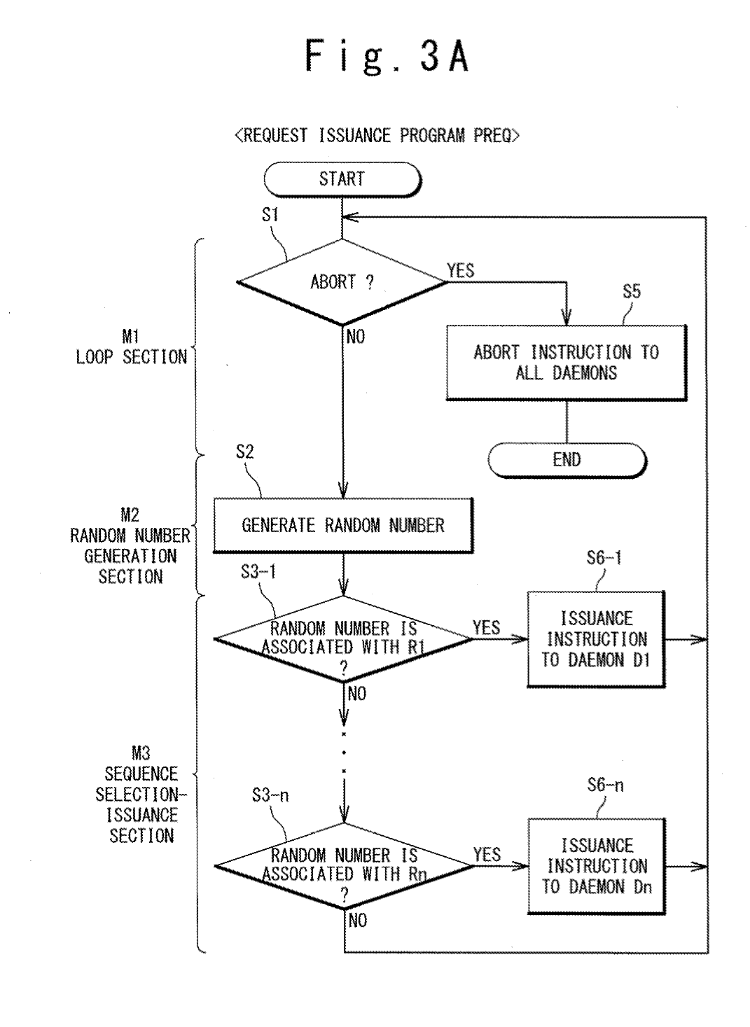

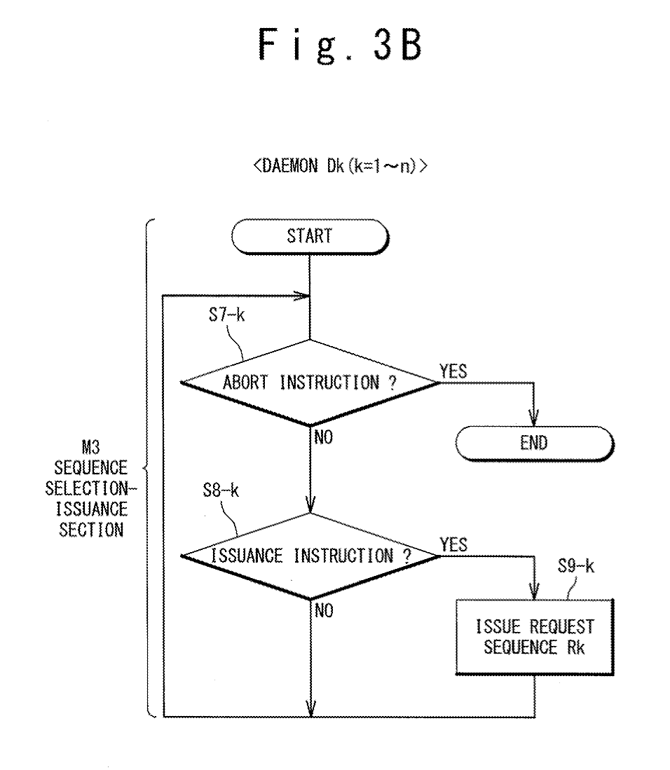

Moreover, the request issuance program PREQ is not limited to the one shown in FIG. 2 and can be comprised of a plurality of programs. FIGS. 3A and 3B conceptually show another example of the request issuance program PREQ according to the present exemplary embodiment. In the present example, the request issuance program PREQ is provided with a daemon section (FIG. 3B) playing a role of only issuing each request sequence and a main section (FIG. 3A) giving instructions to the daemon section. The request sequences R1 to Rn are respectively issued by different daemons, and one daemon Dk plays a role of issuing one request sequence Rk (k=1 to n).

As in the case of FIG. 2, if the predetermined abort condition is satisfied (Step S1; Yes), the loop section M1 stops the processing. More specifically, the loop section M1 transmits an abort instruction to the all daemons (Step S5). When receiving the abort instruction (Step S7-k; Yes), each daemon Dk stops processing. Moreover, the sequence selection-issuance section M3 selects and issues one request sequence that is related to the one number obtained by the random number generation section M2. More specifically, if the number is associated with the request sequence Rk (Step S3-k; Yes), the sequence selection-issuance section M3 transmits an issuance instruction to the daemon Dk (Step S6-k). When receiving the issuance instruction (Step S8-k; Yes), the daemon Dk issues the request sequence Rk (Step S9-k). As a result, the same processing as in the case of FIG. 2 can be achieved.

As described above, various examples are possible for the request issuance program PREQ. In either case, the request issuance program PREQ has the loop section M1, the random number generation section M2 and the sequence selection-issuance section M3. Also, the request issuance program PREQ issues the plurality of types of request sequences R1 to Rn with the specified issuance ratio until the predetermined abort condition is satisfied.

3. System Performance Test Apparatus

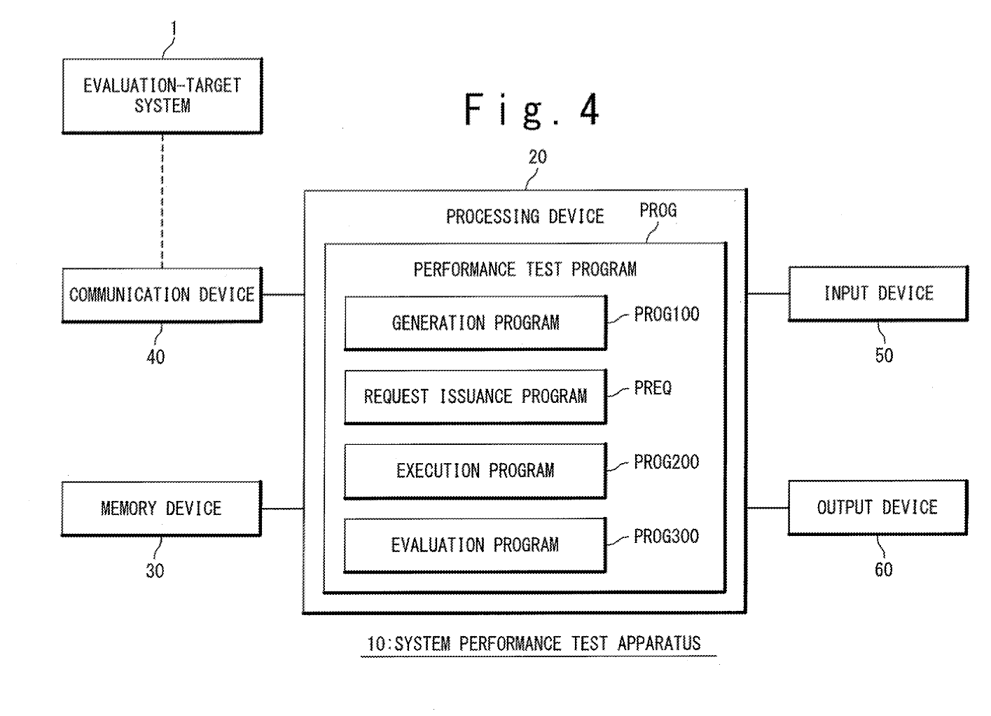

FIG. 4 is a block diagram showing a configuration of a system performance test apparatus 10 according to the present exemplary embodiment. The system performance test apparatus 10 is an apparatus for testing the performance of the evaluation-target system 1 and is connected to the evaluation-target system 1 through a network such that communication is possible.

The evaluation-target system 1 is for example a Web server system. The Web server system is provided with at least one server. The Web server system is often comprised of a plurality of physical servers. The reason is that a Web application is often built by using three kinds of servers; a Web server, an application server and a database server. Sometimes, the Web server and the application server are provided by one physical server, and another physical server is prepared as the database server. Moreover, by using a virtualization technology in recent years, a plurality of virtual machines built on one physical server may be operated as the above-mentioned three kinds of servers.

The system performance test apparatus 10 is a computer and is provided with a processing device 20, a memory device 30, a communication device 40, an input device 50 and an output device 60. The processing device 20 includes a CPU and performs various kinds of data processing. The memory device 30 is exemplified by an HDD (Hard Disk Drive), a RAM (Random Access Memory) and the like. The communication device 40 is a network interface connected to the network. The input device 50 is exemplified by a key board, a mouse, a media drive and the like. The output device 60 is exemplified by a display and the like.

The processing device 20 executes a performance test program PROG to achieve performance test processing for the evaluation-target system 1. The performance test program PROG is a software program executed by a computer and is typically recorded on a computer-readable recording medium. The processing device 20 reads the performance test program PROG from the recording medium and executes it.

The performance test program PROG includes a generation program PROG100, an execution program PROG200 and an evaluation program PROG300. The generation program PROG100 generates the above-described request issuance program PREQ. The execution program PROG200 executes the generated request issuance program PREQ. The evaluation program PROG300 measures an internal state (performance) of the evaluation-target system 1 during the execution of the request issuance program PREQ, and reports the measurement result.

4. Performance Test Processing

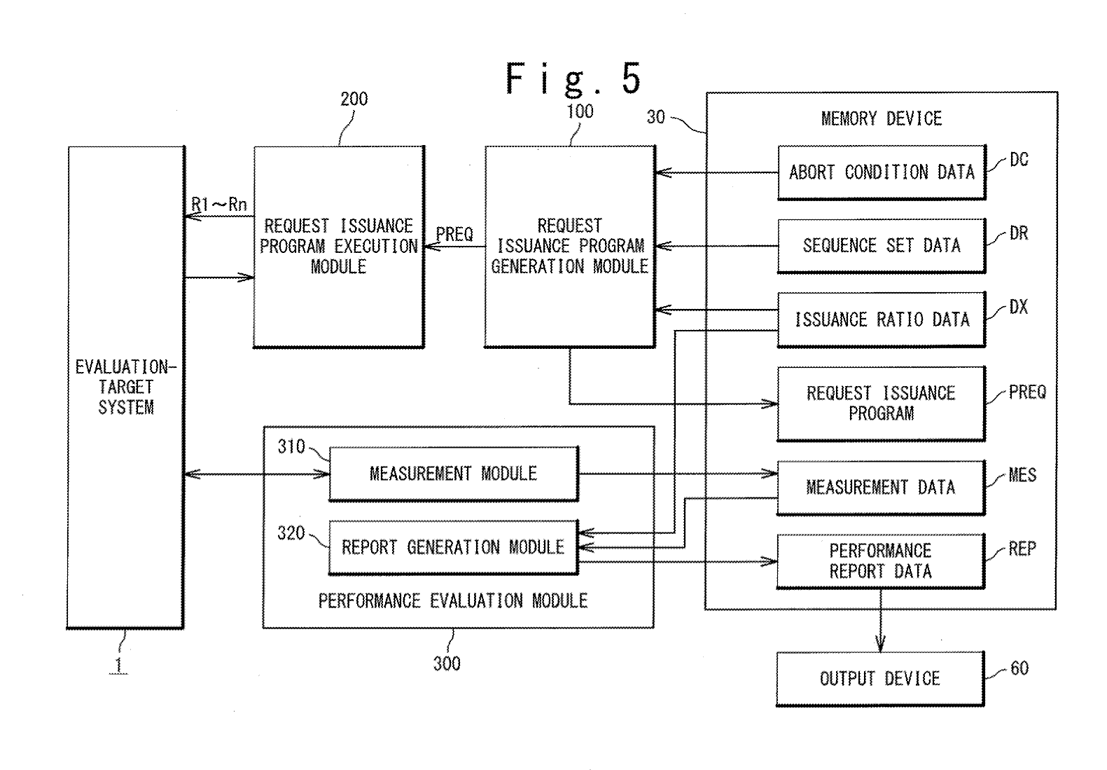

Next, the processing by the system performance test apparatus 10 shown in FIG. 4 will be described in detail. FIG. 5 shows function blocks of the system performance test apparatus 10 and data flows in the performance test. As shown in FIG. 5, the system performance test apparatus 10 is provided with a request issuance program generation module 100, a request issuance program execution module 200 and a performance evaluation module 300. The request issuance program generation module 100 is achieved by the processing device 20 executing the generation program PROG100. The request issuance program execution module 200 is achieved by the processing device 20 executing the execution program PROG200. The performance evaluation module 300 is achieved by the processing device 20 executing the evaluation program PROG300.

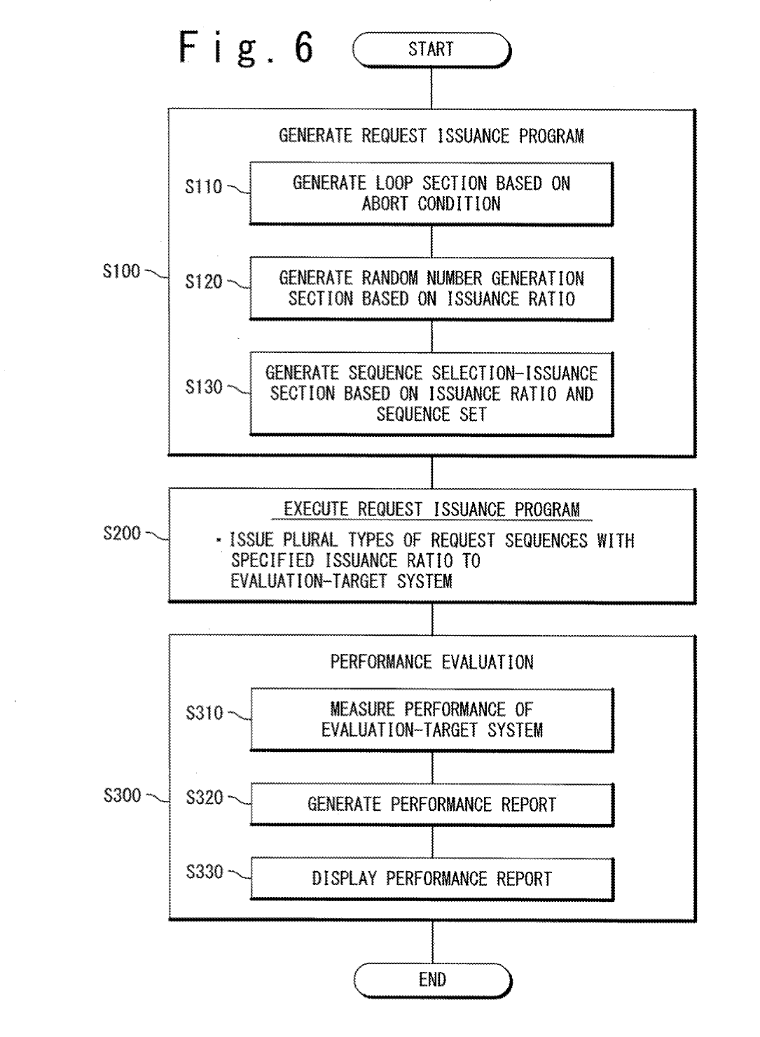

FIG. 6 shows a flow of the performance test processing according to the present exemplary embodiment. Hereinafter, the processing in each step will be described in detail by appropriately referring to FTGS. 4 to 6.

4-1. Step S100

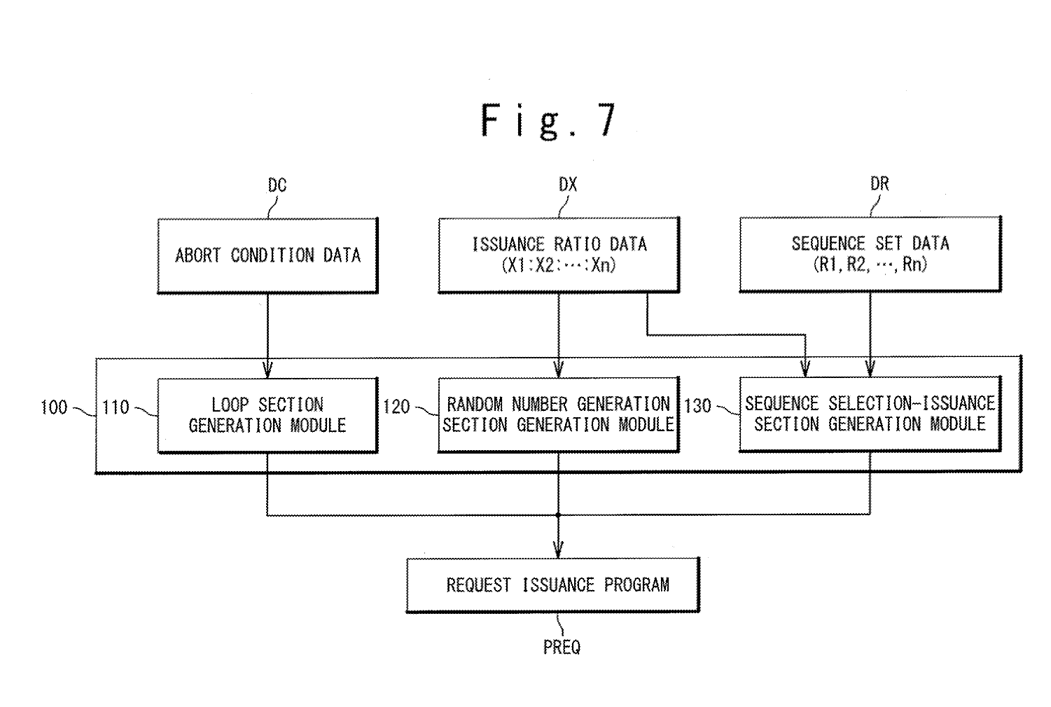

The request issuance program generation module 100 generates the request issuance program PREQ based on an abort condition data DC, a sequence set data DR and an issuance ratio data DX stored in the memory device 30. FIG. 7 shows function blocks of the request issuance program generation module 100. The request issuance program generation module 100 includes a loop section generation module 110, a random number generation section generation module 120 and a sequence selection-issuance section generation module 130.

(Step S110)

The loop section generation module 110 reads the abort condition data DC from the memory device 30. The abort condition data DC indicates the abort condition for the request issuance program PREQ to be generated. The abort condition is exemplified by “30 minutes has passed since the start of program execution”, “key input by a user” and the like. Based on the abort condition data DC, the loop section generation module 110 generates the loop section M1 of the request issuance program PREQ (refer to FIGS. 2 and 3A).

(Step S120)

The random number generation section generation module 120 reads the issuance ratio data DX from the memory device 30. The issuance ratio data DX specifies the issuance ratio X1:X2: . . . :Xn. Based on the issuance ratio data DX, the random number generation section generation module 120 generates the random number generation section M2 of the request issuance program PREQ (refer to FIGS. 2 and 3A). In order to generate the random number generation section M2, a built-in function rand provided by a hardware or a library for programming language processing may be utilized, as mentioned above. What kind of random numbers is to be generated can be determined from the issuance ratio X1:X2: . . . :Xn (or the summation X1+X2+ . . . + Xn).

(Step S130)

The sequence selection-issuance section generation module 130 reads the issuance ratio data DX and the sequence set data DR from the memory device 30. The sequence set data DR gives the request sequence set (the plurality of types of request sequences R1 to Rn) shown in FIG. 1. The sequence selection-issuance section generation module 130 generates the sequence selection-issuance section M3 of the request issuance program PREQ based on the request sequences Ri to Rn and the issuance ratio X1:X2: . . . :Xn thereof (refer to FIGS. 2, 3A and 3B). More specifically, as described above, the i-th request sequence Ri is related to a set of Xi numbers among (X1+X2+ . . . +Xn) numbers generated by the random number generation section M2. As a result, the sequence selection-issuance section M3 that selectively issues a request sequence related to the generated random number can be generated.

In this manner, the request issuance program PREQ is completed. The request issuance program generation module 100 stored the generated request issuance program PREQ in the memory device 30 and also sends it to the request issuance program execution module 200.

Moreover, the request issuance program generation module 100 can generate the request issuance program PREQ with respect to each of various patterns of issuance ratio. For example, let us consider a case where the issuance ratio data DX indicates a plurality of patterns of the issuance ratio. In this case, the random number generation section generation module 120 and the sequence selection-issuance section generation module 130 select the issuance ratio in order from the issuance ratio data DX and use the selected issuance ratio to generate the random number generation section M2 and the sequence selection-issuance section M3. In this manner, the request issuance program generation module 100 can generate in order the plurality of types of request issuance programs PREQ having the different issuance ratios respectively. The plurality of request issuance programs PREQ are sent to the request issuance program execution module 200 in order.

4-2. Step S200

The request issuance program execution module 200 executes the request issuance program PREQ generated in the Step S100. The processing at this time is the same as that of the request issuance program PREQ (refer to FIGS. 2, 3A and 3B). That is, the request issuance program execution module 200 issues the plurality of types of request sequences R1 to Rn with the specified issuance ratio to the evaluation-target system 1. Moreover, the request issuance program execution module 200 receives from the evaluation-target system 1 a response to each request. The transmission of the request sequence and the reception of the response are performed through the communication device 40. The present Step S200 is executed until the predetermined abort condition is satisfied.

It should be noted that, when respective requests included in a request sequence are issued, the request issuance interval can be arbitrary. After a response to an issuing request is obtained, the next request may be issued immediately or may be issued after waiting for a constant time. Also, the issuance interval may be determined by using uniform random numbers or exponential random numbers. It is also possible to configure the request issuance program PREQ such that a plurality of request issuance processes (threads) are activated and these threads concurrently issue requests to the evaluation-target system 1.

4-3. Step S300

Concurrently with the Step S200, the performance evaluation module 300 measures the performance (internal state) of the evaluation-target system 1. That is, the performance evaluation module 300 measures the performance (internal state) of the evaluation-target system 1 under the processing of the request sequences R1 to Rn. Then, the performance evaluation module 300 outputs the measurement result as a performance report. As shown in FIG. 5, the performance evaluation module 300 includes a measurement module 310 and a report generation module 320.

(Step S310)

The measurement module 310 measures the performance of the evaluation-target system 1. For example, the measurement module 310 measures “CPU utilization” and “throughput” of the server constituting the evaluation-target system 1. The CPU utilization is a rate of processing execution by the CPU per unit time. For example, when the CPU executes processing for only 30% of the unit time and is in an idle state for the remaining 70% of the unit time, the CPU utilization is 0.3 (30%). The throughput is the number of requests that can be processed per unit time. The CPU utilization and the throughput can be obtained by using a function of an OS, a Web server program or the like operating on the evaluation-target system 1. As to the throughput, it can also be calculated based on the number of responses received by the request issuance program execution module 200.

The evaluation-target system 1 may be built by using three kinds of servers: the Web server, the application server and the database server. In this case, the CPU utilization of each server and the throughput of the Web server that first receives the request are measured. Moreover, by using a virtualization technology in recent years, a plurality of virtual machines built on one physical server may be operated as the above-mentioned three kinds of servers. In this case, the CPU utilization may be obtained from an OS on the virtual machine and the CPU utilization of the physical server may be obtained from an OS and VMM (Virtual Machine Monitor) on the physical server.

The measurement module 310 sequentially stores measurement data MES indicating the measured performance in the memory device 30. That is, the measurement data MES is a time-series data of the measured performance (CPU utilization and throughput).

(Step S320)

The report generation module 320 reads the measurement data MES and the issuance ratio data DX from the memory device 30 at a certain timing. Then, the report generation module 320 combines the measurement data MES and the issuance ratio data DX to generate a performance report data REP. The performance report data REP indicates correspondence relationship between the issuance ratio indicated by the issuance ratio data DX and the measured performance indicated by the measurement data MES.

As described above, the measurement data MES indicates the time-series variation in the performance of the evaluation-target system 1. Therefore, the report generation module 320 can calculate an average value or a maximum value of the performance (CPU utilization, throughput) of the evaluation-target system 1 during a predetermined period. The average value or the maximum value may be adopted as the performance depending on the issuance ratio indicated by the issuance ratio data DX. The report generation module 320 generates the performance report data REP indicating the correspondence relationship between the issuance ratio and the calculated performance.

By changing the issuance ratio between various patterns, it is possible to estimate the performance of the evaluation-target system 1 in the cases of the various issuance ratios. In other words, it is possible to know change in the performance depending on the issuance ratio. For example, the plurality of types of request issuance programs PREQ having different issuance ratios are generated in order. Then, the above-described Steps S200, S310 and S320 are performed with respect to each of the request issuance programs PREQ. Each time the request issuance program PREQ having the different issuance ratio is executed, the correspondence relationship between the issuance ratio and the calculated performance is additionally written to the performance report data REP.

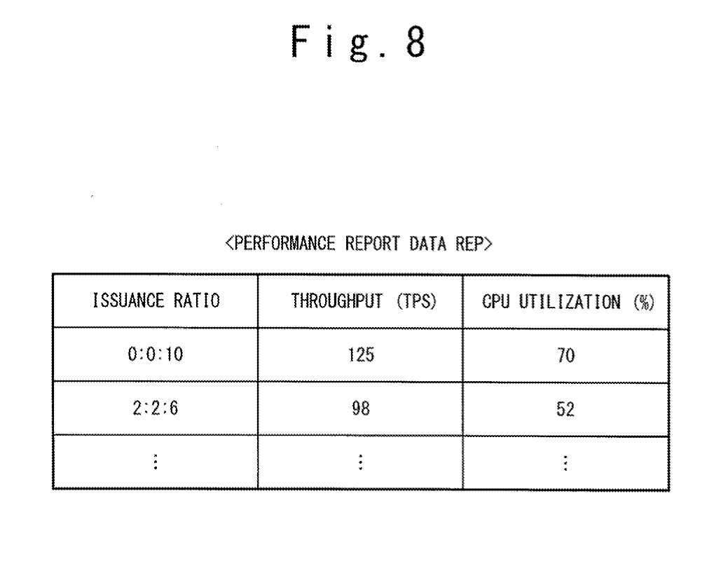

FIG. 8 shows an example of the generated performance report data REP. As shown in FIG. 8, the performance report data REP indicates a correspondence relationship between the plurality of patterns of the issuance ratios each and the performances (throughput, CPU utilization). A unit of the throughput is TPS (Transactions Per Second). By using such the performance report data REP, the user can analyze change in and a variation range of the performance of the evaluation-target system 1 depending on the issuance ratio.

The issuance ratio can also be changed automatically in accordance with a predetermined rule. For example, in the case of the three types of request sequences R1 to R3, distribution of the issuance ratio X1:X2:X3 is changed by one. That is, the issuance ratio (X1:X2:X3) is changed in the following manner; (0:0:5), (0:1:4), (0:2:3), . . . , (1:0:4), (1:1:3), . . . , (5:0:0). As a result, it is possible to comprehensively verify the system performance depending on the various issuance ratios.

(Step S330)

The performance report data REP thus generated by the above-described processing is output as a report to the output device 60 (display or printer). For example, the performance report data REP is displayed on a display. By referring to the display, the user can verify change in and a variation range of the performance of the evaluation-target system 1 depending on the issuance ratio.

5. Effects

According to the present exemplary embodiment, as described above, the request issuance program PREQ that is useful in the performance test of the evaluation-target system 1 is provided. Then, by using the request issuance program PREQ, it is possible to issue the plurality of types of request sequences R1 to Rn with the specified issuance ratio X1:X2: . . . :Xn to the evaluation-target system 1. It is thus possible to perform the performance test of the evaluation-target system 1 while applying the practical load. As a result, precision of the performance test is improved.

Moreover, the issuance ratio varies depending on condition and situation assumed by a system designer or a operations manager. Therefore, to measure the system performance beforehand with assuming various issuance ratios is very useful for the system operation. For example, by using the above-described performance report, the system designer or the operations manager can beforehand make an agreement on guaranteed performance with users of the system. It is also possible to make a plan of system enhancement and contract extension, based on the performance report and operation data.

The present exemplary embodiment is preferable for performance check and performance test for a system operation and administrative task in a data center and the like.

While the exemplary embodiments of the present invention have been described above with reference to the attached drawings, the present invention is not limited to these exemplary embodiments and can be modified as appropriate by those skilled in the art without departing from the spirit and scope of the present invention.

This application is based upon and claims the benefit of priority from Japanese patent, application No. 2008-110326, filed on Apr. 21, 2008, the disclosure of which is incorporated herein in its entirely by reference.

1. A system performance test method for testing performance of a server system, comprising:
issuing a plurality of types of request sequences with a specified issuance ratio to said server system, wherein each of said plurality of types of request sequences is comprised of a sequence of requests to said server system; and
measuring performance of said server system during processing of said plurality of types of request sequences.

2. The system performance test method according to claim 1, further comprising: executing the issuing said plurality of types of request sequences and the measuring performance of said server system, while changing said issuance ratio between a plurality of patterns.

3. The system performance test method according to claim 2, further comprising: generating a performance report data that indicates correspondence relationship between said plurality of patterns of said issuance ratio each and said measured performance.

4. The system performance test method according to claim 3, further comprising: displaying said generated performance report data on a display device.

5. The system performance test method according to claim 1,
wherein said performance includes CPU utilization and throughput of a server constituting said server system.

6. The system performance test method according to claim 1,
wherein the issuing said plurality of types of request sequences is executed until a predetermined abort condition is satisfied.

7. The system performance test method according to claim 6,
wherein the issuing said plurality of types of request sequences comprises:
selecting said plurality of types of request sequences one by one such that said plurality of types of request sequences are selected with said issuance ratio;
issuing said selected request sequence to said server system; and
executing the selecting said plurality of types of request sequences one by one and the issuing said selected request sequence repeatedly until said predetermined abort condition is satisfied.

8. The system performance test method according to claim 7,
wherein said plurality of types of request sequences include first to n-th request sequences,
n is an integer equal to or larger than 2,
said issuance ratio of said first to n-th request sequences is expressed by X1:X2: . . . :Xn,
X1 to Xn are integers, and
the i-th request sequence is related to Xi numbers (i=1 to n),
wherein the selecting said plurality of types of request sequences one by one comprises:
randomly generating a plurality of numbers which include at least numbers respectively related to said plurality of types of request sequences; and
selecting a request sequence related to said generated number from said plurality of types of request sequences.

9. A system performance test program which causes a computer to execute performance test processing that tests performance of a server system,
said performance test processing comprising:
issuing a plurality of types of request sequences with a specified issuance ratio to said server system, wherein each of said plurality of types of request sequences is comprised of a sequence of requests to said server system; and
measuring performance of said server system during processing of said plurality of types of request sequences.

10. A system performance test apparatus for testing performance of a server system, comprising:
an execution module configured to issue a plurality of types of request sequences with a specified issuance ratio to said server system, wherein each of said plurality of types of request sequences is comprised of a sequence of requests to said server system; and
a performance evaluation module configured to measure performance of said server system during processing of said plurality of types of request sequences.

11. The system performance test apparatus according to claim 10, further comprising: a request issuance program generation module configured to generate a request issuance program,
wherein said execution module executes said generated request issuance program to issue said plurality of types of request sequences with said issuance ratio.

12. The system performance test apparatus according to claim 11,
wherein said plurality of types of request sequences include first to n-th request sequences,
n is an integer equal to or larger than 2, said issuance ratio of said first to n-th request sequences is expressed by X1:X2: . . . :Xn,
X1 to Xn are integers, and
the i-th request sequence is related to Xi numbers (i=1 to n),
wherein said request issuance program comprises:
a random number generation section configured to randomly generate a plurality of numbers which include at least numbers respectively related to said plurality of types of request sequences;
a request selection-issuance section configured to select a request sequence related to said generated number from said plurality of types of request sequences and to issue said selected request sequence to said server system; and
a loop section configured to stop processing when a predetermined abort condition is satisfied.

13. The system performance test apparatus according to claim 12,
wherein said request issuance program generation module comprises:
a first module configured to generate said loop section based on an abort condition data that indicates said predetermined abort condition;
a second module configured to generate said random number generation section based on an issuance ratio data that indicates said issuance ratio; and
a third module configured to generate said request selection-issuance section by relating the i-th request sequence to the Xi numbers based on said issuance ratio data and said plurality of types of request sequences.

14. The system performance test apparatus according to claim 13,
wherein said issuance ratio data indicates a plurality of patterns of said issuance ratio, and
said request issuance program generation module generates said request issuance program with respect to each of said plurality of patterns.

15. The system performance test apparatus according to claim 14,
said performance evaluation module generates a performance report data that indicates correspondence relationship between said plurality of patterns of said issuance ratio each and said measured performance.

16. A request issuance program that causes a computer to execute:
issuing a plurality of types of request sequences with a specified issuance ratio to a server system, wherein each of said plurality of types of request sequences is comprised of a sequence of requests to said server system; and
executing the issuing said plurality of types of request sequences until a predetermined abort condition is satisfied.

17. The request issuance program according to claim 16,
wherein said plurality of types of request sequences include first to n-th request sequences,
n is an integer equal to or larger than 2,
said issuance ratio of said first to n-th request sequences is expressed by X1:X2: . . . :Xn,
X1 to Xn are integers, and
the i-th request sequence is related to Xi numbers (i=1 to n),
wherein the issuing said plurality of types of request sequences comprises:
randomly generating a plurality of numbers which include at least numbers respectively related to said plurality of types of request sequences;
selecting a request sequence related to said generated number from said plurality of types of request sequences; and
issuing said selected request sequence to said server system.
